(19) United States
(12) Patent Application Publication
(10) Pub. No.: US 2015/0273792 A1
(43) Pub. Date: Oct. 1, 2015

(54) PROTECTIVE FILM, LAMINATE, DISPLAY DEVICE, AND FILM-ATTACHING UNIT

(71) Applicant: Sony Corporation, Tokyo (JP)

(72) Inventor: Hiroshi Tazawa, Kanagawa (JP)

(73) Assignee: Sony Corporation, Tokyo (JP)

(21) Appl. No.: 14/665,581

(22) Filed: Mar. 23, 2015

(30) Foreign Application Priority Data
Mar. 31, 2014 (JP) 2014-074949

(51) Int. Cl. B32B 3/30; B32B 7/12

(52) U.S. Cl. CPC B32B 3/30; B32B 7/12; B32B 2250/02; B32B 2255/26; B32B 2457/20

(57) ABSTRACT

There is provided a laminate that includes a protective film configured to include an adhesive layer, and a film-attaching layer configured to include an uneven surface to which the protective film is attached via the adhesive layer. The protective film has adhesion of 3 [N/25 mm] to 20 [N/25 mm] inclusive with respect to the uneven surface before pretreatment, and the protective film has the adhesion of 0.05 [N/25 mm] or lower with respect to the uneven surface after the pretreatment.

### CROSS REFERENCE TO RELATED APPLICATIONS

This application claims the benefit of Japanese Priority Patent Application JP 2014-074949 filed Mar. 31, 2014, the entire contents of which are incorporated herein by reference.

### BACKGROUND

The present disclosure relates to a protective film for protecting an uneven surface, and a laminate including the protective film, a display device, and a film-attaching unit.

The use of an anti-reflective film has been recently popular for display devices such as liquid crystal displays, organic EL (Electro Luminescence) displays, and plasma displays; electronic devices such as touchscreens; optical elements such as lenses; and solar cells, for example. This anti-reflective film has been generally a laminated film, and recently, the anti-reflective structure called moth-eye has been studied for use. This anti-reflective structure includes a large number of fine-pitch (1 μm or less) components formed by nanoimprinting, photolithography, or others.

These fine-pitch components are known as being easily damaged when touched, and as being easy to get dirty with oils and fats but difficult to be cleaned. This thus expects the use of a protective film for protecting the fine-pitch components from being damaged or getting dirty during processing and transportation in manufacturing and shipping processes. However, attaching a protective film via an adhesive layer to the fine-pitch components such as moth-eye causes problems. That is, the adhesive penetrates into between the fine-pitch components due to the capillary action, which is typical of the fine-pitch components. The adhesive may also find a way into the resin forming the fine-pitch components. This thus causes a difficulty in removing the protective film due to the anchoring effect. Also due to the cohesive failure of the adhesive, the adhesive remains on the surface of the fine-pitch components so that the surface gets dirty.

For protecting the fine-pitch components, proposed are protective films as below, for example.

Japanese Patent Application Laid-Open No. 2013-1007 (hereinafter, referred to as Patent Document 1) describes a protective film that, substantially, does not adhere to a layer of fine-pitch components. This protective film is disposed on the fine-pitch component layer where the surface is uneven, thereby allowing easy removal thereof on the interface with the fine-pitch component layer. This technology is aimed to prevent reduction of the optical performance before and after the removal of the protective film.

Japanese Patent Application Laid-Open No. 2012-242803 (hereinafter, referred to as Patent Document 2) describes a protective film formed on an optical member by filling a material therefor into the functional fine-patterned uneven surface of the optical member, and curing the material. This technology is aimed to obtain intimate contact between the optical member and the protective film.

### SUMMARY

However, the technologies of Patent Documents 1 and 2 have a difficulty in obtaining the adhesion stability during processing, transportation, or others, and, at the same time, in preventing an adhesive residue after the removal of the protective film.

It is thus desirable to provide a protective film that obtains the adhesion stability, and, at the same time, prevents an adhesive residue. It is also desirable to provide a laminate including the protective film, a display device, and a film-attaching unit.

According to an embodiment of the present disclosure, there is provided a laminate, including

a protective film configured to include an adhesive layer, and

a film-attaching layer configured to include an uneven surface to which the protective film is attached via the adhesive layer, —

the protective film having adhesion of 3 [N/25 mm] inclusive to 20 [N/25 mm] inclusive with respect to the uneven surface before pretreatment, and after the pretreatment, the protective film having the adhesion of 0.05 [N/25 mm] or lower with respect to the uneven surface.

According to another embodiment of the present disclosure, there is provided a display device, including

a protective film configured to include an adhesive layer, and

a display surface configured to include an uneven surface to which the protective film is attached via the adhesive layer; and

the protective film has adhesion of 3 [N/25 mm] or higher with respect to the uneven surface before pretreatment, and after the pretreatment, the protective film has the adhesion of 0.05 [N/25 mm] or lower with respect to the uneven surface.

According to still another embodiment of the present disclosure, there is provided a film-attaching unit, including

a protective film configured to include an adhesive layer, and

an uneven surface to which the protective film is attached via the adhesive layer; and

the protective film has adhesion of 3 [N/25 mm] or higher with respect to the uneven surface before pretreatment, and after the pretreatment, the protective film has the adhesion of 0.05 [N/25 mm] or lower with respect to the uneven surface.

According to still another embodiment of the present disclosure, there is provided a protective film, including

a base, and

an adhesive layer provided to the base; and

adhesion with respect to a film-attaching unit before pretreatment is 3 [N/25 mm] or higher, and the adhesion with respect to the film-attaching unit after the pretreatment is 0.05 [N/25 mm] or lower.

As described above, according to the embodiments of the present disclosure, it is possible to obtain the adhesion stability at the same time to prevent an adhesive residue.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1A is a cross-sectional view of a protective film in an exemplary configuration in a first embodiment of the present disclosure, and FIG. 1B is a cross-sectional view of a laminate in an exemplary configuration in the first embodiment of the present disclosure;

FIGS. 2A and 2B are each a diagram for illustrating how to measure a fill factor;

FIG. 3A is a cross-sectional view of a laminate in an exemplary configuration in Modified Example 1 in the first embodiment of the present disclosure, and FIG. 3B is a cross-sectional view of a laminate in an exemplary configuration in Modified Example 2 in the first embodiment of the present disclosure;

FIG. 4 is a cross-sectional view of a laminate in an exemplary configuration in Modified Example 3 in the first embodiment of the present disclosure;

FIG. 5A is a schematic view of a display device with an exemplary outer appearance in a second embodiment of the present disclosure, and FIG. 5B is a cross-sectional view of the display device taken along the line A-A in FIG. 5A.

### DETAILED DESCRIPTION OF EMBODIMENTS

Based on the past experiences of the inventors of the present application, reducing the adhesion of an adhesive indeed prevents an adhesive residue after the removal of a protective film because the adhesive has a difficulty in getting into fine-pitch components. However, the reduced adhesion of the adhesive causes a partial adhesion failure or film peeling during processing and transportation. On the other hand, increasing the adhesion of the adhesive indeed prevents a partial adhesion failure or film peeling during processing and transportation, but easily leaves an adhesive residue after removing the protective film. That is, this is a tradeoff between obtaining the adhesion stability during processing, transportation, and others, and preventing an adhesive residue after the removal of the protective film.

The inventors of the present application have been intensively studied to obtain the adhesion stability at the same time to prevent the adhesive residue, which are the tradeoff as described above. With the study, the inventors have found the specific adhesion for a protective film to obtain the adhesion stability at the same time to prevent an adhesive residue when the protective film is adhered to the uneven surface, i.e., the adhesion of 3 [N/25 mm] inclusive to 20 [N/25 mm] inclusive before pretreatment, and the adhesion of 0.05 [N/25 mm] or lower after the pretreatment.

The expression of “pretreatment” means a process to be performed on an adhesive layer before the removal of a protective film. This process is aimed to reduce the adhesion of the protective film. The pretreatment is desirably an ultraviolet radiation (hereinafter, referred to as “UV radiation”) process, but this is not restrictive. A device for UV radiation is desirably a metal halide lamp, for example, but this is not restrictive. Alternatively, a UV light source that emits light of a single wavelength may be used, e.g., UV laser, or an LED (Light Emitting Diode)-UV.

The protective film is attached to a film-attaching layer or to the surface of a film-attaching unit, desirably to the uneven surface for use. This is for protecting the film-attaching layer or the surface of the film-attaching unit. More desirably, the protective film is attached to the uneven surface on which convex or concave portions are formed with a pitch of 1 μm or less. The protective film is desirably attached to the surface of an optical element, to the display surface of a display device or others, and to the input surface of an input device, for example. These surfaces are desirably made uneven with fine-pitch components such as moth-eye structure. Alternatively, the protective film may be attached to the surface of a fine-patterned wiring circuit in an electronic component, for example.

Examples of the film-attaching unit include an optical element, an electronic component, an optical apparatus, and an electronic apparatus.

Examples of the optical element include a lens, a filter, a semitransmissive mirror, a dimmer, a prism, a polarizing element, and a front plane for display use, but this is not restrictive.

Examples of the electronic component include an imaging element package, an imaging module, and an electronic component including a fine-patterned wiring circuit, but this is not restrictive. Examples of the electronic component including a fine-patterned wiring circuit include a semiconductor device such as DMD (Digital Micro-Mirror Device), RAM (Random Access Memory), and ROM (Read Only Memory); an imaging element such as CCD (Charge Coupled Device) and CMOS (Complementary Metal Oxide Semiconductor); and an input device such as touchscreen, but this is not restrictive.

Examples of the optical apparatus include a telescope, a microscope, an exposure device, a measurement device, an inspection device, and an analysis device, but this is not restrictive.

Examples of the electronic apparatus include a personal computer, a mobile phone, a tablet computer, a display device, and an imaging device, but this is not restrictive.

Examples of the display device include a liquid crystal display (LCD), a plasma display panel (PDP), an organic EL display, an inorganic EL display, an LED display, a field emission display (FED), a surface-conduction electron-emitter display (SED), and an electronic paper display, but this is not restrictive.

Examples of the imaging device include a digital camera, and a digital video camera, but this is not restrictive.

Hereinafter, embodiments of the present disclosure will be described in the following order with reference to the drawings. In the drawings for the embodiments, any similar or corresponding components are provided with the same reference numeral.

1. First Embodiment (exemplary protective film, and exemplary laminate including the protective film)
2. Second Embodiment (exemplary display device)

### 1. First Embodiment

### Configuration of Protective Film

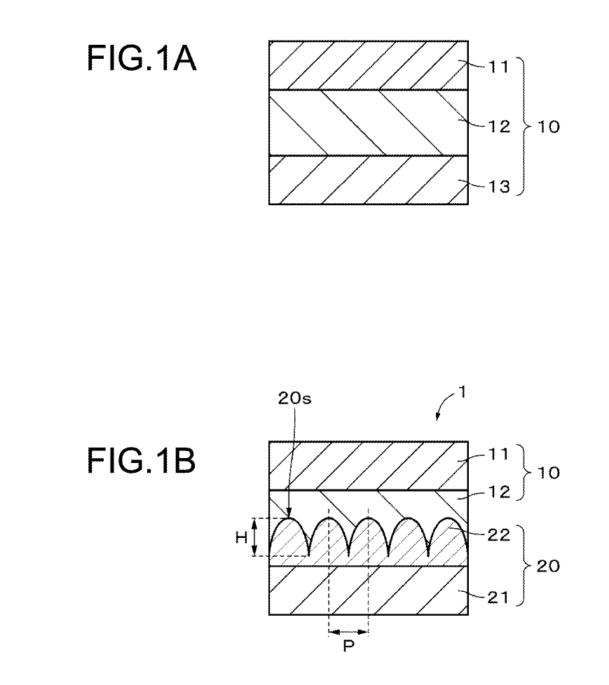

As shown in FIG. 1A, a protective film 10 in a first embodiment of the present disclosure includes a base 11, and an adhesive layer 12 provided on the base 11. The protective film 10 may additionally include a release layer 13 on the adhesive layer 12 as appropriate.

### [Configuration of Laminate]

As shown in FIG. 1B, a laminate 1 in the first embodiment of the present disclosure includes the above-mentioned protective film 10, and a fine-pitch component layer (film-attaching layer) 20. This fine-pitch component layer 20 includes a fine-pitch uneven surface 20s, to which the protective film 10 is attached via the adhesive layer 12.

These components, i.e., the fine-pitch component layer 20, the base 11, the adhesive layer 12, and the release layer 13, are described below in order.

### [Fine-Pitch Component Layer]

The fine-pitch component layer 20 includes a base 21, and a plurality of fine-pitch components 22 provided on the base 21. These fine-pitch components 22 configure the fine-pitch uneven surface 20s. FIG. 1B shows an exemplary configuration in which the base 21 is formed separately from the fine-pitch components 22, but alternatively, the base 21 may be integrally formed with the fine-pitch components 22.

The fine-pitch components 22 are arranged one- or two-dimensionally on the surface of the base 21, for example. The arrangement pattern may be regular or irregular. The fine-pitch components 22 are protruded from the surface of the base 21 (convex portions), or are recessed thereon (concave portions). The fine-pitch components 22 are formed with a pitch P of 1 μm or less, and each have the height H of 1 μm or less, for example. Examples of the fine-pitch components 22 include moth-eye structure, diffraction grating, and fine-patterned wiring, but this is not restrictive. The fine-pitch components 22 may be formed by nanoimprinting or photolithography, but this is not restrictive.

When the fine-pitch uneven surface 20s is anti-reflective, the fine-pitch components 22 are desirably formed with the pitch P, which is less than the wavelength of light. This is for reducing reflection of light. The wavelength of light for reducing reflection of light is the wavelength of ultraviolet light, the wavelength of visible light, or the wavelength of infrared light, for example. The wavelength of ultraviolet light is 10 nm or more and 350 nm or less, the wavelength of visible light is from 350 nm to 850 nm inclusive, and the wavelength of infrared light is more than 850 nm and 1 mm or less.

### [Base]

The base 11 may be made of a material being transparent or not transparent with visible light, for example. The base 11 may be a film, a sheet, a plate, or a block, for example.

The base 11 may be made of an inorganic or organic material. The inorganic material includes quartz, sapphire, glass, ceramic, or metal, for example. The organic material includes polyethylene terephthalate (PET), polypropylene (PP), polyethylene (PE), polycarbonate (PC), polyethersulfone (PES), polyarylate (PAR), or others, but these materials are not specifically restrictive. Alternatively, the organic material may be used with various additives as appropriate, e.g., light stabilizer, UV absorber, antistatic agent, flame retardant, or antioxidant.

### [Adhesive Layer]

The adhesive layer 12 of the protective film 10 has the characteristics of being sufficiently adhesive before the UV radiation process (pretreatment), and of becoming less adhesive after the UV radiation process (pretreatment).

In the first embodiment, described is the example of reducing the adhesion of the adhesive layer 12 by the UV radiation process, but the adhesion of the adhesive layer 12 may be reduced by the pretreatment other than the UV radiation process.

Before the UV radiation process, the protective film 10 has the adhesion of 3 [N/25 mm] to 20 [N/25 mm] inclusive, desirably the adhesion of 5[N/25 mm] to 20[N/25 mm] inclusive with respect to the fine-pitch uneven surface 20s. When the adhesion of the protective film 10 is lower than 3 [N/25 mm], for example, this reduces the degree of contact with the fine-pitch uneven surface 20s, thereby often causing a partial adhesion failure of the protective film 10 and peeling thereof during processing and transportation, for example. On the other hand, when the adhesion of the protective film 10 is higher than 20[N/25 mm], the adhesive in the adhesive layer 12 may often remain on the fine-pitch uneven surface 20s when the protective film 10 is removed therefrom after the UV radiation process. Hereinafter, this is referred to as “adhesive residue”.

After the UV radiation process, the protective film 10 has the adhesion of 0.05 [N/25 mm] or lower with respect to the fine-pitch uneven surface 20s. When the adhesion of the protective film 10 becomes higher than 0.05 [N/25 mm], an adhesive residue may be often observed when the protective film 10 is removed from the fine-pitch uneven surface 20s after the UV radiation process.

Before the UV radiation process, a fill factor of the fine-pitch uneven surface 20s with respect to the adhesive layer 12 (specifically a fill factor of the fine-pitch components 22 with respect to the adhesive layer 12) is desirably 75% or higher. When the fill factor is lower than 75%, for example, this reduces the degree of contact with the fine-pitch uneven surface 20s, thereby causing a partial adhesion failure of the protective film 10 and peeling thereof during processing and transportation, for example. Herein, the fill factor being lower than 75% as above may be because the adhesive layer 12 has a high modulus of elasticity, or the adhesive layer 12 is thin in thickness, for example.

The above-mentioned fill factor is specifically defined as below.

Fill Factor=(D/H)×100[%]

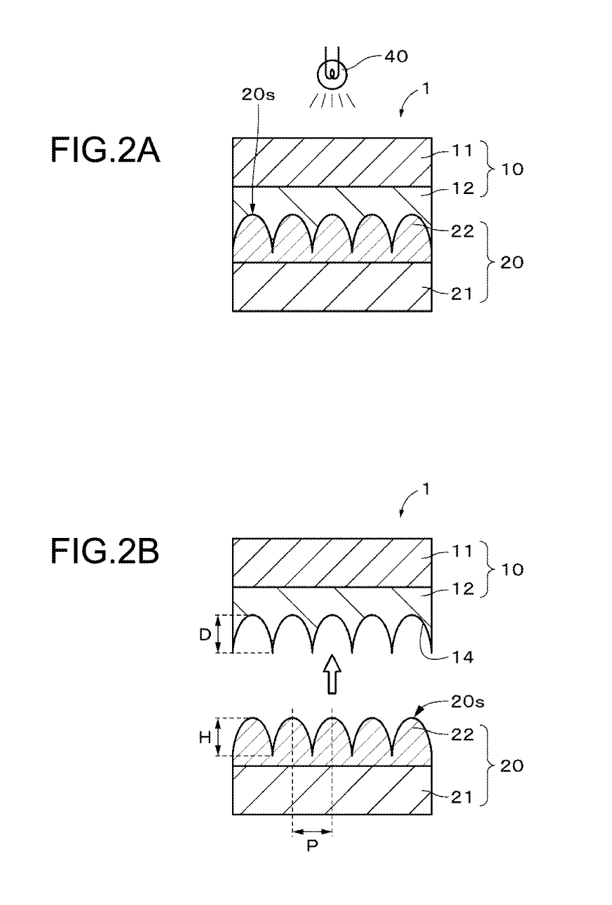

(where H denotes the height of the fine-pitch components 22 (refer to FIG. 2B), and D denotes the depth of each concave portion 14 imprinted by the fine-pitch components 22 to the adhesive layer 12 (refer to FIG. 2B).

The shrinkage of the adhesive layer 12 after the pretreatment is desirably 3% or higher, and more desirably is 5% or higher. When the shrinkage is lower than 3%, the adhesion of the protective film 10 may be higher than 0.05 [N/25 mm] after UV radiation, thereby often resulting in an adhesive residue.

Described next is how to measure the height H of the fine-pitch components 22, and the depth D of the concave portions 14. First of all, as shown in FIG. 2A, using a UV radiation device 40 such as metal halide lamp, the UV radiation process is performed on the adhesive layer 12 of the protective film 10 to reduce the adhesion thereof. Thereafter, as shown in FIG. 2B, the protective film 10 is removed from the fine-pitch uneven surface 20s. Next, immediately after the removal of the protective film 10, the exposed surface of the adhesive layer 12 is observed using an AFM (Atomic Force Microscope) so as to measure the depth D of the concave portions 14 imprinted by the fine-pitch components 22 to the adhesive layer 12 (refer to FIG. 2B). The removed fine-pitch uneven surface 20s is also observed using the AFM so as to measure the height H of the fine-pitch components 22 (refer to FIG. 2B).

The adhesive layer includes an adhesive. The adhesive includes an adhesive resin, a cross-linking agent, and a UV curable resin, for example. The adhesive may additionally include additives as appropriate, e.g., UV absorber, catalyst, coloring agent, antistatic agent, slip additive, leveling agent, antifoaming agent, polymerization accelerator, antioxidant, flame retardant, infrared absorber, surface active agent, surface modifier, thixotropic agent, or plasticizer.

The adhesive resin is an adhesive component in the adhesive layer 12. The adhesive resin includes various types of acrylic adhesive resin such as acrylic ester. Examples of the cross-linking agent include isocyanate cross-linking agent and epoxy cross-linking agent.

The composition of UV curable resin includes a (meth) acryloyl-group-containing compound (hereinafter, referred to as “(meth)acrylate”), and an initiator. Herein, the (meth)acryloyl group means an acryloyl group or a methacryloyl group. The (meth)acrylate means acrylate or methacrylate. As for (meth)acrylate, one or two or more (meth)acrylic monomers, (meth)acrylic oligomers, or others may be combined for use.

Specific examples of the (meth)acrylate include trimethylol propane tri(meth)acrylate, dipentaerythritol penta(meth)acrylate, dipentaerythritol hexa(meth)acrylate, ditrimethylolpropane tetra(meth)acrylate, and the like, but these materials are not restrictive.

Examples of the initiator include 2,2-dimethoxy-1,2-diphenylethane-1-on, 1-hydroxy-cyclohexyl phenyl ketone, and 2-hydroxy-2-methyl-1-phenylpropane-1-on.

The content of the UV curable resin is desirably more than 10 parts by mass but is 40 parts by mass or less, per 100 parts by mass of the adhesive resin, and more desirably, is 15 parts by mass or more but 30 parts by mass or less. When the content of the UV curable resin becomes 10 parts by mass or more, this obtains the sufficient cure shrinkage by the UV radiation process because the UV curable resin occupies a large portion of the adhesive resin. Therefore, the adhesion of the adhesive layer 12 after UV radiation is reduced to 0.05 [N/25 mm] or lower so that an adhesive residue is prevented. On the other hand, when the content of the UV curable resin is 40 parts by mass or less, this increases the degree of cross-linking of the adhesive resin so that the adhesive residue is further prevented.

The number of functional groups in the UV curable resin is desirably three or more but five or less. When the UV curable resin includes a (meth)acryloyl-group-containing compound, the number of functional groups is as many as the (meth)acryloyl groups (the number of functional groups). With the three or more functional groups, the UV radiation process obtains the sufficient cure shrinkage so that the adhesion of the adhesive layer after UV radiation is sufficiently reduced, and an adhesive residue is prevented. On the other hand, with the five or less functional groups, the UV curable resin itself is reduced in viscosity so that the compatibility is improved between the UV curable resin and the adhesive. This obtains a good mixture between the adhesive resin such as acrylic adhesive resin and the component of the UV curable resin. Therefore, when the composition for forming the adhesive layer is coated on the base 11, matrices are well formed, thereby preventing the sea-island structure with large grains. The adhesive-layer-forming composition being in such a state helps to further prevent the adhesive residue if the protective film 10 is removed after UV radiation on the adhesive layer 12.

### [Release Layer]

The release layer 13 is a so-called separator, and is a film, for example. The release layer 13 includes a base, and a release-agent layer formed on the base. The base is exemplified by a paper sheet, a plastic film such as PET film, or a plastic laminated sheet. The release-agent layer is made of a release agent such as silicone. The release layer 13 is removed from the adhesive layer 12 when the protective film 10 is attached to the film-adhering surface, e.g., the fine-pitch uneven surface 20s.

### [Manufacturing Method of Protective Film]

Described below is a manufacturing method of the protective film 10 in the above-mentioned configuration.

First of all, a composition for forming the adhesive layer is prepared by mixing and stirring the acrylic adhesive resin, the cross-linking agent, and the UV curable resin. The adhesive-layer-forming composition may be diluted with a solvent as appropriate. The solvent for dilution includes toluene, ethyl acetate, butyl acetate, methyl ethyl ketone (MEK), and methyl isobutyl ketone (MIBK), or others which may be used alone or in combination of two or more.

Next, the base 11 may be processed on the surface for easy adhesion as appropriate. For easy adhesion, the surface of the base 11 may be subjected to corona treatment, plasma treatment, or flame treatment, but this is not restrictive.

Next, the obtained adhesive-layer-forming composition is coated and dried on the surface of the base 11, thereby forming the adhesive layer 12. The composition may be coated by die coating, gravure coating, micro gravure coating, or others, but these are not specifically restrictive. Next, the adhesive layer 12 is attached thereon with the release layer 13 as appropriate, and the resulting structure is cured for a predetermined length of time. This obtains the protective film 10 for use.

### [Use of Protective Film]

Described below is an exemplary use of the protective film 10 in the above-mentioned configuration.

First of all, before the process of manufacturing, shipping, or others, the protective film 10 is attached to the fine-pitch uneven surface 20s of the fine-pitch component layer 20 via the adhesive layer 12, thereby obtaining the laminate 1. After the attachment, the adhesive layer 12 (before the UV radiation process) has the adhesion of 3 [N/25 mm] to 20 [N/25 mm] inclusive, desirably 5 [N/25 mm] to 20 [N/25 mm] inclusive. With the protective film 10 attached as above, the fine-pitch uneven surface of the fine-pitch component layer 20 is protected during processing or transportation, for example. Next, after the process of manufacturing, shipping, or others, the adhesive layer 12 is subjected to the UV radiation process. With the adhesive layer 12 subjected to the UV radiation process, the UV curable resin in the adhesive layer 12 is cross-linked by the photo polymerization initiator so that the adhesive layer 12 is cured and shrunk. In this manner, the adhesive having gotten into the fine-pitch components 22 is removed away from the surface thereof. This allows easy removal of the adhesive layer 12 from the fine-pitch uneven surface 20s. The adhesive layer 12 after the UV radiation process has the adhesion of 0.05 [N/25 mm] or lower. Next, the protective film 10 is removed from the fine-pitch uneven surface 20s of the fine-pitch component layer 20.

### [Effect]

The protective film 10 in the first embodiment has the adhesion of 3 [N/25 mm] or higher for attachment to the fine-pitch uneven surface 20s before the UV radiation process, and after the UV radiation process, has the adhesion of 0.05 [N/25 mm] or lower therefor. This accordingly obtains the adhesion stability during processing, transportation, and others, and, at the same time, prevents an adhesive residue after the removal of the protective film 10. This also provides the protective film 10 that may protect the fine-pitch uneven surface 20s with no or little adhesive residue left thereon, thereby being able to improve the yield and eliminate the need of a cleaning process after processing.

As is sufficiently adhesive before the UV radiation process, the protective film 10 may not be peeled off even if the laminate 1 is processed by cutting, stamping, or dicing, for example. The protective film 10 may thus protect the fine-pitch uneven surface 20s of the fine-pitch component layer 20. To be more specific, the protective film 10 may not be peeled off from the fine-pitch uneven surface 20s of the fine-pitch component layer 20 even by the shearing force during processing, or by the powerful flow of cool water during processing, for example.

With the protective film 10 in the first embodiment, the adhesive layer 12 is subjected to the UV radiation process before the protective film 10 is removed from the fine-pitch uneven surface 20s. This is for reducing the adhesion of the adhesive layer 12 so that the adhesive residue is prevented at the time of film removal. On the other hand, when the adhesive layer 12 remains rather adhesive due to no UV radiation process thereon, it means that the adhesive has gotten into the fine-pitch components 22 by the capillary phenomenon. If the protective film 10 is removed from the fine-pitch uneven surface 20s with the adhesive layer 12 being in such a state, the anchoring effect causes the cohesive failure of the adhesive at the time of film removal, and the adhesive thus remains inside of the fine-pitch components 22. The adhesive remained as above resultantly buries the concave portions between the fine-pitch components 22, and any desired properties may not be fully achieved. This is also known with general protective films including adhesive layers.

### MODIFIED EXAMPLES

### Modified Example 1

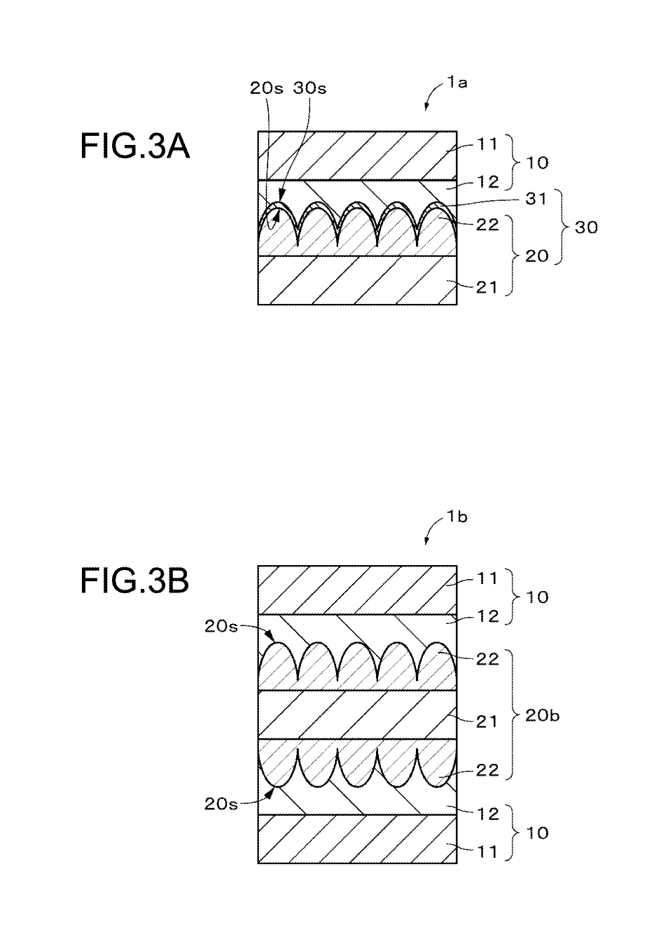

As shown in FIG. 3A, a laminate 1a in Modified Example 1 in the first embodiment includes the protective film 10, and a fine-pitch component layer 30 that is conductive. This conductive fine-pitch component layer 30 includes a conductive fine-pitch uneven surface 30s to which the protective film 10 is attached. The conductive fine-pitch component layer 30 also includes the fine-pitch component layer 20, and a conductive layer 31 that is provided along the fine-pitch uneven surface 20s of the fine-pitch component layer 20. The conductive layer 31 may be an antistatic layer or an electrode, and may be patterned into any desired shape, for example.

The conductive layer 31 is a metal layer or a transparent conductive layer, for example. The metal layer includes at least one selected from Ag (silver), Al (aluminum), Cu (copper), Ti (titanium), Au (gold), Pt (platinum), Nb (niobium), and the like. The transparent conductive layer includes at least one selected from conductive polymers, metal nanoparticles, carbon nanotubes, transparent oxide semiconductors, and the like.

### Modified Example 2

As shown in FIG. 3B, a laminate 1b in Modified Example 2 in the first embodiment includes two of the protective film 10, and a fine-pitch component layer 20b. In the fine-pitch component layer 20b, the fine-pitch uneven surface 20s is provided on both sides of the base 21. The fine-pitch uneven surfaces 20s on both sides of the base 21 are each attached with the protective film 10.

### Modified Example 3

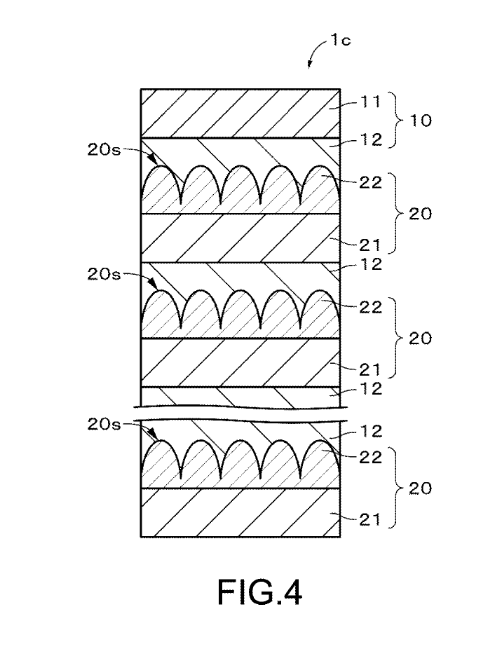

As shown in FIG. 4, a laminate 1c in Modified Example 3 in the first embodiment includes a plurality of fine-pitch component layers 20, and the adhesive layer 12 provided between each two of the fine-pitch component layers 20. The laminate 1c desirably additionally includes the protective film 10, which is attached to the fine-pitch uneven surface 20s of the uppermost fine-pitch component layer 20. The laminate 1c is so configured that not only the fine-pitch component layer 20 but also the adhesive layer 12 therebelow are removed at the same time. That is, the adhesive layer 12 is adhered better to the rear surface of the fine-pitch component layer 20 than to the fine-pitch uneven surface of the fine-pitch component layer 20. Between the adhesive layer 12 and the rear surface of the fine-pitch component layer 20, a release-agent layer containing silicone or others may be additionally provided. Herein, the rear surface of the fine-pitch component layer 20 means the surface opposite to the fine-pitch uneven surface 20s.

### 2. Second Embodiment

In a second embodiment, described is an example of providing the protective film 10 in the first embodiment to the display surface (fine-pitch uneven surface) of a display device being a film-attaching unit.

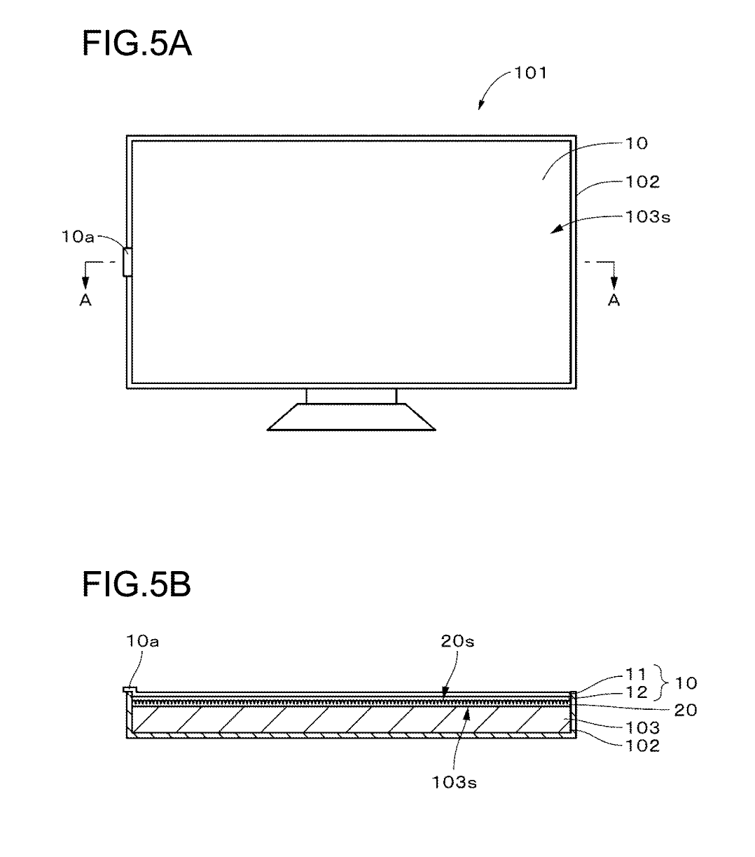

As shown in FIGS. 5A and 5B, a display device 101 includes a chassis 102, a display panel 103, the fine-pitch component layer 20, and the protective film 10. The display panel 103 is housed in the chassis 102, and the fine-pitch component layer 20 is provided to a display surface 103s of the display panel 103. The protective film 10 is provided to the fine-pitch uneven surface 20s of the fine-pitch component layer 20. In the second embodiment, described is a case where the display device 101, more specifically the display panel 103 is a film-attaching unit. However, the film-attaching unit to be attached with the protective film 10 is not restricted to such an example.

The fine-pitch uneven surface 20s is desirably a moth-eye structure. The rear surface of the fine-pitch component layer 20 is attached to the display surface 103s of the display panel 103 via an adhesive layer (not shown), for example. The protective film 10 is provided on the circumferential edge with a pinch portion 10a, which is pinched to pull the protective film 10 toward the front so that the protective film 10 is removed from the fine-pitch uneven surface 20s of the fine-pitch component layer 20.

In the display device 101 in the second embodiment, the protective film 10 is attached to the fine-pitch uneven surface 20s provided to the display device 101 being a film-attaching unit. This accordingly prevents the protective film 10 from being peeled off from the fine-pitch uneven surface 20s or from resulting in a partial adhesion failure during assembly or transportation of the display device 101, for example. Moreover, this eliminates or reduces an adhesive residue on the fine-pitch uneven surface 20s after the removal of the protective film 10.

### EXAMPLES

In the below, Examples of the present disclosure are specifically described, and these Examples are not restrictive.

### Example 1

### Manufacturing Process of Optical Element

An optical element is manufactured by forming a moth-eye structure on a glass substrate by UV nanoimprinting.

### [Manufacturing Process of Protective Film]

First of all, the following materials are mixed and stirred to obtain a composition for forming an adhesive layer.

Acrylic adhesive resin (SK-1223 manufactured by Soken Chemical & Engineering Co., Ltd.): 100 parts by mass

Cross-linking agent (CORONATE (trademark) L manufactured by Nippon Polyurethane Industry Co., Ltd.): 5 parts by mass

UV curable resin (KAYARAD (trademark) THE-330 manufactured by Nippon Kayaku. Co., Ltd.): 15 parts by mass

Photo polymerization initiator (IRGACURE (trademark) 184 manufactured by BASF SE): 5 parts by mass

Solvent (ethyl acetate): 150 parts by mass

Next, by die coating, the resulting adhesive-layer-forming composition is coated and dried on a PET film (base) with the thickness of 10 μm so that an adhesive layer is obtained. Next, this adhesive layer is attached with a PET release film (release layer), and then the structure is cured at room temperature for seven days. This obtains a protective film for use.

### [Lamination Process]

The resulting protective film is disposed on the optical element in such a manner that the adhesive layer of the protective film faces the moth-eye surface of the optical element. Thereafter, the pressure of 9.8 N/mm² is applied to the protective film using a loading roller for attachment thereof to the optical element. After the attachment, the structure is left for an hour. This obtains a laminate for use.

### Example 2

A laminate is obtained similarly to Example 1 except that the amount of the UV curable resin is changed to 25 parts by mass.

### Example 3

A laminate is obtained similarly to Example 1 except that the amount of the UV curable resin is changed to 30 parts by mass.

### Example 4

A laminate is obtained similarly to Example 1 except that the acrylic adhesive resin is changed to SK-1633 manufactured by Soken Chemical & Engineering Co., Ltd., and the amount thereof is changed to 30 parts by mass.

### Comparison Example 1

A laminate is obtained similarly to Example 1 except that the acrylic adhesive resin is changed to SK-1760 manufactured by Soken Chemical & Engineering Co., Ltd., and the amount thereof is changed to 30 parts by mass.

### Comparison Example 2

A laminate is obtained similarly to Example 1 except that the acrylic adhesive resin is changed to SK-1499M manufactured by Soken Chemical & Engineering Co., Ltd., and the amount thereof is changed to 30 parts by mass.

### Comparison Example 3

A laminate is obtained similarly to Example 1 except that the amount of the UV curable resin is changed to 10 parts by mass.

### Comparison Example 4

A laminate is obtained similarly to Example 1 except that the amount of the UV curable resin is changed to 0.

### Example 5

A laminate is obtained similarly to Example 1 except that the amount of the UV curable resin is changed to 45 parts by mass.

### Comparison Example 5

A laminate is obtained similarly to Example 1 except that the UV curable resin is changed to KAYARAD (trademark) R-712 manufactured by Nippon Kayaku. Co., Ltd., and the amount thereof is changed to 30 parts by mass.

### Example 6

A laminate is obtained similarly to Example 1 except that the UV curable resin is changed to KAYARAD (trademark) DPCA-20 manufactured by Nippon Kayaku. Co., Ltd., and the amount thereof is changed to 30 parts by mass.

### [Assessment]

Assessments are made as below on the laminates of Examples 1 to 5, and those of Comparison Examples 1 to 5 obtained as above. Note that the assessments on the laminate of Comparison Example 4 are partially skipped because the adhesive layer thereof includes no UV curable resin.

### [Tension Test Before UV Radiation]

The adhesion of the protective film to the optical element is measured using a tension tester (Autograph-AG-20 manufactured by Shimadzu Corporation) with the angle for removal of 180°, and with the speed for removal of 300 mm/sec. Table 1 shows the results thereof.

[Tension Test after UV Radiation]

Using a device for UV radiation (metal halide lamp), the laminate is exposed to UV light of 1000 mJ from the protective film side. Thereafter, the adhesion of the protective film 10 is measured similarly to the “tension text before UV radiation” described above. Table 1 shows the results thereof.

### [Cure Shrinkage]

First of all, the adhesive layer of the protective film is marked at two spots before UV radiation thereto, and the distance between these two spots is measured, i.e., distance Dₐ. Next, using the device for UV radiation (metal halide lamp), the laminate is exposed to UV light of 1000 mJ from the protective film side, and then the distance between the two marks is measured again, i.e., distance D_{b}.

Next, calculated is the ratio of the distance D_{b} after UV Radiation to the distance Dₐ before UV radiation, i.e., (D_{b}/Dₐ)×100 [%]. The resulting ratio is used as the cure shrinkage. Table 1 shows the results thereof.

### [Fill Factor]

First of all, using the device for UV radiation (metal halide lamp), the laminate is exposed to UV light of 1000 mJ from the protective film side, and then the protective film is removed. Next, the surface of the adhesive layer immediately after the removal of the protective film is observed by an AFM so as to measure the depth D of the concave portions imprinted by the moth-eye structure to the protective layer. Next, the moth-eye structure after the removal of the protective layer is observed similarly by the AFM so as to measure the height H thereof. Next, calculated is the ratio of the depth D of the concave portions to the height H of the moth-eye structure, i.e., (D/H)×100 [%]), and the resulting ratio is used as the fill factor. Table 1 shows the results thereof.

### [Partial Adhesion Failure of Protective Film]

Based on the calculation result of “fill factor” described above, an assessment is made to determine whether there is a partial adhesion failure of the protective film with criteria as below.

There is a partial adhesion failure of the protective film: when the fill factor is lower than 75%

There is no partial adhesion failure of the protective film: when the fill factor is 75% or higher

### [Adhesive Residue]

First of all, using the device for UV radiation (metal halide lamp), the laminate is exposed to UV light of 1000 mL from the protective film side, and then the protective film is removed. Next, using an optical microscope for dark-field observation, the laminate is observed to check whether the adhesive is transferred to the moth-eye surface of the optical element. Table 1 shows the results thereof by “A”, “B”, and “C”, the meaning of which is as below.

“A”: No transfer of adhesive to the moth-eye surface is observed, and there is no influence on the anti-reflective properties of the moth-eye structure

“B”: Slight transfer of adhesive to the moth-eye surface is observed, but there is little influence on the anti-reflective properties of the moth-eye structure (acceptable)

“C”: Transfer of adhesive to the moth-eye surface is observed, and the anti-reflective properties of the moth-eye structure are impaired

### [Results]

Table 1 shows the configurations and assessment results of the protective films in Examples 1 to 6, and those in Comparison Examples 1 to 5.

TABLE 1

| | Acrylic adhesive | | | | | | | | Partial | | Outer |
|---|---|---|---|---|---|---|---|---|---|---|---|
| | resin | | Ultraviolet curable resin | | | Adhesion | | | adhesion | | appearance |
| | | Amount | | Number of | Amount | Before UV | After UV | Fill | failure of | Cure | (Assessment |
| | | [Parts | | functional | [Parts | radiation | radiation | factor | protective | shrinkage | on adhesive |
| | Type | by mass] | Type | groups | by mass] | [N/25 mm] | [N/25 mm] | [%] | film? | [%] | residue) |
| Example 1 | SK-1223 | 100 | THE-330 | 3 | 15 | 3.2 | 0.048 | 93% | No | 3.2 | A |
| Example 2 | SK-1223 | 100 | THE-330 | 3 | 25 | 3.5 | 0.032 | 93% | No | 3.6 | A |
| Example 3 | SK-1223 | 100 | THE-330 | 3 | 30 | 3.7 | 0.021 | 92% | No | 4.2 | A |
| Example 4 | SK-1633 | 100 | THE-330 | 3 | 30 | 18.5 | 0.045 | 95% | No | 3.1 | A |
| Comparison | SK-1760 | 100 | THE-330 | 3 | 30 | 23 | 0.065 | 96% | No | 4 | C |
| Example 1 | | | | | | | | | | | |
| Comparison | SK-1499M | 100 | THE-330 | 3 | 30 | 2.1 | 0.015 | 71% | Yes | 4.1 | A |
| Example 2 | | | | | | | | | | | |
| Comparison | SK-1223 | 100 | THE-330 | 3 | 10 | 3.2 | 0.055 | 96% | No | 1.8 | C |
| Example 3 | | | | | | | | | | | |
| Comparison | SK-1223 | 100 | — | — | 0 | 3.1 | — | — | No | — | C |
| Example 4 | | | | | | | | | | | |
| Example 5 | SK-1223 | 100 | THE-330 | 3 | 45 | 3.9 | 0.02 | 92% | No | 5.1 | B |
| Comparison | SK-1223 | 100 | R-712 | 2 | 30 | 3.6 | 0.062 | 96% | No | 2.6 | C |
| Example 5 | | | | | | | | | | | |
| Example 6 | SK-1223 | 100 | DPCA-20 | 6 | 30 | 3.3 | 0.033 | 91% | No | 5.6 | B |

Table 2 shows the adhesion of the acrylic adhesive resin itself used to manufacture the protective films in Examples 1 to 6, and those in Comparison Examples 1 to 5.

TABLE 2

| | Adhesion |
|---|---|
| Acrylic adhesive resin | [N/25 mm] |
| Soken Chemical Engineering Co., Ltd. SK-1223 | 3.1 |
| Soken Chemical Engineering Co., Ltd. SK-1449M | 1.8 |
| Soken Chemical Engineering Co., Ltd. SK-1760 | 21 |
| Soken Chemical Engineering Co., Ltd. SK-1633 | 16 |

From Table 1, the following is found.
In Examples 1 to 6, the protective film before UV radiation has the adhesion of 3 [N/25 mm] to 20 [N/25 mm] inclusive, and after UV radiation, has the adhesion of 0.05 [N/25 mm] or lower. These protective films obtain adhesion stability and, at the same time, prevent an adhesive residue.
In Comparison Example 1, the acrylic adhesive resin in use has the adhesion extremely higher than those in Examples 1 to 6. Therefore, the protective film before UV radiation has the adhesion higher than 20 [N/25 mm], and after UV radiation, has the adhesion higher than 0.05[N/25 mm]. Such a protective film being high in adhesion after UV radiation leaves an adhesive residue.
In Comparison Example 2, the acrylic adhesive resin in use has the adhesion lower than those in Examples 1 to 6. Therefore, the protective film before UV radiation has the adhesion lower than 3 [N/25 mm]. With such a protective film being low in adhesion before UV radiation, the fill factor is lower than 75%. That is, the protective film results in a partial adhesion failure.
In Comparison Example 3, the amount of UV curable resin is reduced to 10 parts by mass compared with those in Examples 1 to 6 so that the cure shrinkage is lower than 3%. Therefore, the adhesion of the protective film after UV radiation exceeds 0.05 [N/25 mm], thereby resulting in a partial adhesion failure.
In Comparison Example 4, the UV curable resin is not used to make the adhesive-layer-forming composition, thereby resulting in a partial adhesion failure.
In Example 5, the amount of UV curable resin is increased to 45 parts by mass compared with those in Examples 1 to 4 so that a slight adhesive residue is observed. However, this is acceptable because the anti-reflective properties of the moth-eye structure are not greatly affected thereby.
In Comparison Example 5, the number of functional groups in the UV curable resin is less than three. Therefore, the cure shrinkage is lower than 3% because the protective film does not cure and shrink enough. As a result, the adhesion of the protective film after UV radiation exceeds 0.05 [N/25 mm], thereby resulting in an adhesive residue.
In Example 6, the number of functional groups in the UV curable resin is more than five. Therefore, a slight adhesive residue is observed, but this is acceptable because the anti-reflective properties of the moth-eye structure are not greatly affected thereby.

While the first embodiment, modified examples thereof, and the second embodiment of the present disclosure have been described in detail, the foregoing description is in all aspects illustrative and not restrictive. It is understood that numerous other modifications and variations may be devised without departing from the scope of the present disclosure.

For example, the configurations, methods, processes, shapes, materials, and numerical values referred to in the first embodiment, modified examples thereof, and the second embodiment of the present disclosure are by way of example and may vary as appropriate.

Moreover, the configurations, methods, processes, shapes, materials, and numerical values referred to in the first embodiment, modified examples thereof, and the second embodiment of the present disclosure may be combined for use without departing from the scope of the present disclosure.

The present disclosure may be also in the following structures.

(1) A laminate, including:

a protective film configured to include an adhesive layer; and

a film-attaching layer configured to include an uneven surface to which the protective film is attached via the adhesive layer,

the protective film having adhesion of 3 [N/25 mm] inclusive to 20 [N/25 mm] inclusive with respect to the uneven surface before pretreatment, and after the pretreatment, the protective film having the adhesion of 0.05 [N/25 mm] or lower with respect to the uneven surface.

(2) The laminate according to (1), in which

a convex or concave portion of the uneven surface is formed with a pitch of 1 μm or less.

(3) The laminate according to (1) or (2), in which

the adhesive layer after the pretreatment is with a shrinkage factor of 3% or higher.

(4) The laminate according to any one of (1) to (3), in which

the uneven surface is with a fill factor of 75% or higher with respect to the adhesive layer.

(5) The laminate according to any one of (1) to (4), in which

the adhesive layer contains an adhesive resin, a cross-linking agent, and an ultraviolet curable resin.

(6) The laminate according to (5), in which

the number of functional groups in the ultraviolet curable resin is three or more but five or less.

(7) The laminate according to (5) or (6), in which

a content of the UV curable resin is more than 10 parts by mass but 40 parts by mass or less, per 100 parts by mass of the adhesive resin.

(8) The laminate according to any one of (1) to (7), in which

the pretreatment is radiation of ultraviolet light.

(9) A display device, including:

a protective film configured to include an adhesive layer; and

a display surface configured to include an uneven surface to which the protective film is attached via the adhesive layer,

the protective film having adhesion of 3 [N/25 mm] or higher with respect to the uneven surface before pretreatment, and after the pretreatment, the protective film having the adhesion of 0.05 [N/25 mm] or lower with respect to the uneven surface.

(10) A film-attaching unit, including:

a protective film configured to include an adhesive layer; and

an uneven surface to which the protective film is attached via the adhesive layer,

the protective film having adhesion of 3 [N/25 mm] or higher with respect to the uneven surface before pretreatment, and after the pretreatment, the protective film having the adhesion of 0.05 [N/25 mm] or lower with respect to the uneven surface.

(11) A protective film, including:

a base; and

an adhesive layer provided to the base,

adhesion with respect to a film-attaching unit before pretreatment being 3 [N/25 mm] or higher, and the adhesion with respect to the film-attaching unit after the pretreatment being 0.05 [N/25 mm] or lower.

It should be understood by those skilled in the art that various modifications, combinations, sub-combinations and alterations may occur depending on design requirements and other factors insofar as they are within the scope of the appended claims or the equivalents thereof.

What is claimed is:

1. A laminate, comprising:
a protective film configured to include an adhesive layer; and
a film-attaching layer configured to include an uneven surface to which the protective film is attached via the adhesive layer,
the protective film having adhesion of 3 [N/25 mm] inclusive to 20 [N/25 mm] inclusive with respect to the uneven surface before pretreatment, and after the pretreatment, the protective film having the adhesion of 0.05 [N/25 mm] or lower with respect to the uneven surface.

2. The laminate according to claim 1, wherein
a convex or concave portion of the uneven surface is formed with a pitch of 1 μm or less.

3. The laminate according to claim 1, wherein
the adhesive layer after the pretreatment is with a shrinkage factor of 3% or higher.

4. The laminate according to claim 1, wherein
the uneven surface is with a fill factor of 75% or higher with respect to the adhesive layer.

5. The laminate according to claim 1, wherein
the adhesive layer contains an adhesive resin, a cross-linking agent, and an ultraviolet curable resin.

6. The laminate according to claim 5, wherein
the number of functional groups in the ultraviolet curable resin is three or more but five or less.

7. The laminate according to claim 5, wherein
a content of the UV curable resin is more than 10 parts by mass but 40 parts by mass or less, per 100 parts by mass of the adhesive resin.

8. The laminate according to claim 1, wherein
the pretreatment is radiation of ultraviolet light.

9. A display device, comprising:
a protective film configured to include an adhesive layer; and
a display surface configured to include an uneven surface to which the protective film is attached via the adhesive layer,
the protective film having adhesion of 3 [N/25 mm] or higher with respect to the uneven surface before pretreatment, and after the pretreatment, the protective film having the adhesion of 0.05 [N/25 mm] or lower with respect to the uneven surface.

10. A film-attaching unit, comprising:
a protective film configured to include an adhesive layer; and
an uneven surface to which the protective film is attached via the adhesive layer,
the protective film having adhesion of 3 [N/25 mm] or higher with respect to the uneven surface before pretreatment, and after the pretreatment, the protective film having the adhesion of 0.05 [N/25 mm] or lower with respect to the uneven surface.

11. A protective film, comprising:
a base; and
an adhesive layer provided to the base,
adhesion with respect to a film-attaching unit before pretreatment being 3 [N/25 mm] or higher, and the adhesion with respect to the film-attaching unit after the pretreatment being 0.05 [N/25 mm] or lower.
